(19) United States
(12) Patent Application Publication
(10) Pub. No.: US 2011/0131204 A1
(43) Pub. Date: Jun. 2, 2011

(54) Deriving Asset Popularity by Number of Launches

(75) Inventors: William K. Bodin, Austin, TX (US); David Jaramillo, Boca Raton, FL (US); Derral C. Thorson, Austin, TX (US)

(73) Assignee: International Business Machines Corporation, Armonk, NY (US)

(21) Appl. No.: 12/629,770

(22) Filed: Dec. 2, 2009

(51) Int. Cl. G06F 17/30

(52) U.S. Cl. 707/727; 707/E17.109

(57) ABSTRACT

An embodiment of the invention includes a method for searching for mobile assets (e.g., mobile telephone applications and/or web applications) based on popularity. The popularities of the mobile assets are determined by monitoring usage of the assets, e.g., downloading of assets and/or launching of assets. Popularities of the mobile assets are also determined by gathering and analyzing user feedback of the assets, e.g., user tags and/or user quality ratings. Search queries for assets are also monitored to determine asset popularity. A search query for a requested asset is received from a requesting mobile device. Results of the search query are weighed with the popularities of the assets; and, the results of the search query are sent to the requesting mobile device. The results of the search query are also sent to an interface. A repository of assets are created based on the popularities of the assets.

### FIELD OF THE INVENTION

The present invention is in the field of methods, systems, and computer program products for deriving asset popularity by number of launches.

### SUMMARY OF THE INVENTION

An embodiment of the invention includes a method for searching for mobile assets (e.g., mobile telephone applications and/or web applications) based on popularity. The popularities of the mobile assets are determined by monitoring usage of the assets, e.g., downloading of assets and/or launching of assets. Popularities of the mobile assets are also determined by gathering and analyzing user feedback of the assets, e.g., user tags and/or user quality ratings. Search queries for assets are also monitored to determine asset popularity.

A search query for a requested asset is received from a requesting mobile device. Results of the search query are weighed with the popularities of the assets; and, the results of the search query are sent to the requesting mobile device. The results of the search query are also sent to an interface. In at least one embodiment, the results of the search query only include assets having user tags. In another embodiment, the results of the search query only include assets having user quality ratings above a predetermined threshold. A repository of assets are created based on the popularities of the assets.

### BRIEF DESCRIPTION OF THE SEVERAL VIEWS OF THE DRAWINGS

The present invention is described with reference to the accompanying drawings. In the drawings, like reference numbers indicate identical or functionally similar elements.

FIG. 1 is a flow diagram illustrating a method for searching for mobile assets according to an embodiment of the invention;

FIG. 2 illustrates a system for searching for mobile assets according to an embodiment of the invention; and

FIG. 3 illustrates a computer program product according to an embodiment of the invention.

### DETAILED DESCRIPTION

Exemplary, non-limiting, embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

At least one embodiment of the invention includes a method to determine, store, and post to a greater network, details relating to a mobile asset's popularity. The method creates a specific function that is used in a social networking system, in which users can search for mobile assets (e.g., mobile applications and web applications). The popularity relevancy for the assets is determined and is consistently updated according to the usage of the assets.

An embodiment of the invention includes a client mobile application that serves as an organizer of assets, both web applications and true applications such as platform-specific applications or platform-neutral applications. The client mobile application interacts with a backend server repository which is comprised of at least one database, a server (e.g., a hypertext transfer protocol server), and associated web services.

In at least one embodiment, the client mobile application includes a backend repository, which is a server that provides assets to mobile devices (e.g., cellular telephones) via a set of web services. When assets are used by the mobile devices, the web services record the time, date, location, list of asset(s) used, user feedback regarding the asset(s) used (e.g., user tags and/or user quality ratings), and/or list of the mobile device(s) using the asset(s). These metrics are collected, stored in a database, and subsequently retrieved to determine the popularity of the assets.

The client mobile application is used to organize potentially hundreds of assets. The mobile client application monitors a particular asset, at the time of launch and throughout the use of the asset, to determine the popularity of the asset in use. Provisions in the functions support the local store of these metrics and/or the direct and immediate communication of these metrics to the backend server infrastructure through a web service interface. These associations allow users of the backend system to search more specifically for applications that will address their needs based on the real-time gathering and accumulation of popularity metrics.

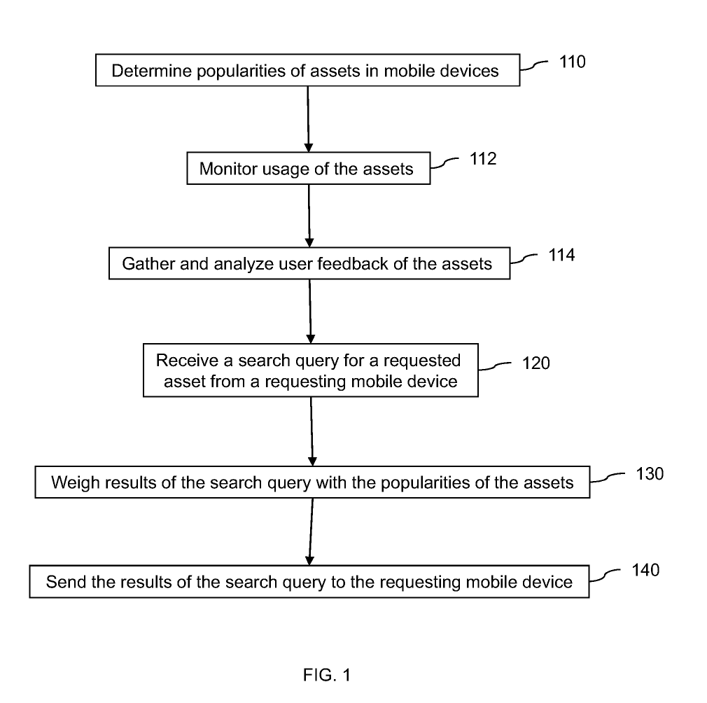

FIG. 1 is a flow diagram illustrating a method for searching for mobile assets (e.g., mobile telephone applications and/or web applications) based on popularity according to an embodiment of the invention. A processor determines popularities of assets in mobile devices (110) by monitoring usage of the assets (112). The usage of the assets includes downloading of assets (e.g., downloading a codec for an MP3 player) and/or launching of assets (e.g., invoking a weather report web application). In another embodiment, usage of the assets also includes the number of times an asset was shared with another user. In at least one embodiment, when assets are used by mobile devices, the web services providing the assets record at least one of the time, date, location, list of asset(s) used, and list of mobile device(s) using the asset(s). As described above, these metrics are stored in a database within or connected to a backend server repository.

In at least one embodiment of the invention, a popularity score is assigned to an asset based on the total number of times the asset is used. In another embodiment, the popularity score is based on the number of mobile devices using the asset. In yet another embodiment, the popularity score is based on the total number of times the asset is used and the number of mobile devices using the asset. Thus, for example, an assets used 20 times by 20 different people is assigned a higher popularity score than an asset used 20 times by only 2 people.

In another embodiment of the invention, the popularity score is also based on the number of times that an asset is used within a fixed time period (e.g., as determined by the user or an administrator of the system). Thus, for example, an asset used 20 times in one day is assigned a lower popularity score than an asset used 20 times in one month (which may indicate sustained popularity over a longer period of time).

In another embodiment, repeated use of an asset within a predetermined window will result in each use after, for example, the first use receiving less weight. The lower weights, in at least one embodiment, are consistently declining, while in another embodiment, the rate of weight decrease could decelerate or accelerate, for example, subject to a second order equation or exponential function. The decrease weight may instead begin after a use later than the second use. In another embodiment, the increase and/or decrease of weight for subsequent uses levels off after a predetermined time period, to account for the potential experimental/trial use of the asset during the variable weight period.

In yet another embodiment, higher popularity scores are assigned to assets that are used in a particular network (e.g., as determined by a user or an administrator of the system). Thus, for example, higher popularity scores are assigned to assets used by mobile devices registered in the user's network.

In addition to monitoring asset usage, the processor also gathers and analyzes user feedback of the assets (114). More specifically, popularity is determined based on the number and type of user tags and/or an aggregate of user quality ratings. Users who recommend a particular asset electronically mark/label the recommended asset with a user tag. In another embodiment, the user tags are associated with assets that are not recommended by users. In yet another embodiment, the net positive or negative value of the total combined user tags is used, e.g., if an asset has 87 positive user tags and 71 negative user tags, the asset has a positive user tag value of 16.

The user feedback also includes user quality ratings, such as, for example, a five-star rating system, a numerical rating system, an alphabetical grading system, and/or a binary scoring system (e.g., a thumbs up/down system). In at least one embodiment, the processor analyzes user quality ratings for assets from multiple sources having different grading systems to create a uniform rating system for the assets based on the scores from the different grading systems.

In another embodiment, the popularities of assets are also determined by monitoring search queries for the assets. For instance, assets that are frequently searched for (e.g., MP3 media codecs) are deemed popular by the processor. At least one embodiment of the invention creates a repository of popular assets based on data from the processor.

A communication module receives a search query for a requested asset from a requesting mobile device (120). A ranking module of the processor weighs results of the search query with the popularities of the assets (130). Specifically, higher rankings are assigned to assets that are more popular (i.e., higher popularity scores based on high usage and/or positive user feedback).

In at least one embodiment, the weights of the usage metrics are equal to the weights of the feedback metrics (i.e., 50%, 50%). Similarly, the user tags are weighed equally respective to the user quality ratings. In another embodiment, the usage metrics are more important (i.e., weighed heavier) than the user feedback metrics; and, the user quality ratings are weighed heavier than the user tags. Another embodiment weighs the user feedback metrics higher than the usage metrics, and the user tags higher than the user quality ratings.

In still another embodiment, the ranking module creates two separate search results, including first search results weighed with the usage metrics (e.g., downloading and/or launching of the assets) and second search results weighed with the user feedback metrics (e.g., user tags and/or user quality ratings). Another embodiment separates the second search results into search results weighed based on user tags and search results weighed based on user quality ratings.

The communication module sends the results of the search query to the requesting mobile device (140). In at least one embodiment, the results of the search query are also sent to an interface. For example, a user can go to a website and view search results for the search query “Internet radio stations”. At least one embodiment of the invention also sends one or more recommended assets to the requesting mobile device based on the popularity metrics (i.e., usage and/or user feedback metrics). For example, the communication module also sends recommended assets for booking hotel reservations to supplement search results for the query “rental cars”.

In at least one embodiment of the invention, the user and/or system administrator programs the ranking module and/or communication module to only send assets meeting predetermined criteria. For example, the user programs the communication module to only send assets in the search results that include usage scores above a predetermined threshold, e.g., assets that have been used by mobile devices of users in his or her network. In another example, the administrator programs the ranking module to only send assets that have been used within the past month.

In still another example, the communication module is programmed to only send assets that include a user quality rating (single, average, and/or combined) above a predetermined threshold. For example, the user programs the communication module to only send assets having one or more user reviews of a 3-star rating or higher. In another example, the user programs the communication module to only send assets having more thumbs up ratings than thumbs down ratings. In still another example, the system administrator programs the communication module to only send assets having an average score of 7 or more out of 10. In yet another example, the communication module only sends assets that include at least 100 user tags.

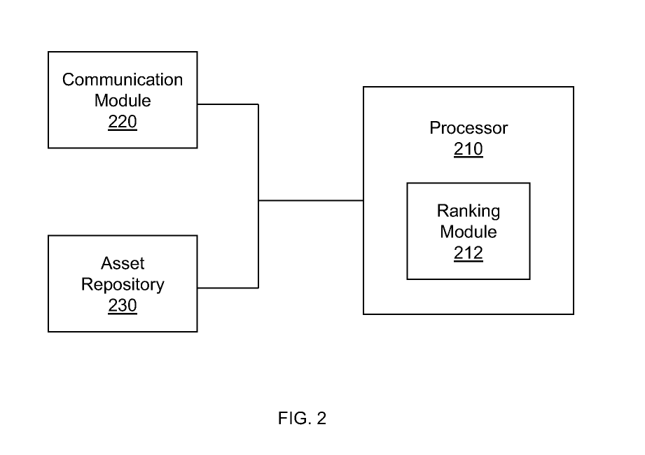

FIG. 2 illustrates a system for searching for mobile assets according to an embodiment of the invention. More specifically, the system includes a processor 210 that determines popularities of the assets in mobile devices. The processor 210 monitors usage of the assets, which includes downloading of assets (e.g., downloading a media player for playing music files) and/or launching of assets (e.g., invoking a traffic report application). As described above, when assets are used by mobile devices, the web services providing the assets record the time, date, location, list of asset(s) used, and/or list of mobile device(s) using the asset(s).

In addition to monitoring asset usage, the processor 210 also gathers and analyzes user feedback of the assets. The user feedback includes user tags, which are placed on particular assets by users who recommend the assets. In another embodiment, the user tags are associated with assets that are not recommended by users. The user feedback also includes user quality ratings, such as, for example, a five-star rating system, a numerical rating system, an alphabetical grading system, and/or a thumbs up/down scoring system.

In yet another embodiment, the processor 210 monitors search queries for assets to further determine an asset's popularity. For instance, assets that are frequently searched for (e.g., ring tones for cellular telephones) are deemed popular by the processor.

The system further includes a communication module 220 operatively connected to the processor 210. The communication module 220 receives search queries for requested assets from requesting mobile devices. A ranking module 212 in the processor 210 weighs results of the search query with the popularities of the assets. In another embodiment, the ranking module 212 is positioned outside of the processor 210.

The ranking module 212 assigns higher rankings to assets that are more popular (i.e., higher popularity scores based on high usage and/or positive user feedback). In at least one embodiment, the ranking module 212 creates two separate search results, including first search results weighed with the usage metrics and second search results weighed with the user feedback metrics.

The communication module 220 sends the results of the search query to the requesting mobile device. In at least one embodiment, the communication module 220 is directly wired to the processor 210. In another embodiment, the communication module 220 includes a third-party controlled cellular telephone tower that is remotely located from the processor 210. In at least one embodiment, the results of the search query are also sent to an interface. For example, a user can go to a website and view search results for the search query “cellular telephone wallpaper”.

In at least one embodiment of the invention, the user and/or administrator of the system programs the ranking module 212 and/or communication module 220 to only send assets meeting predetermined criteria. For example, the user programs the communication module 220 to only send assets in the search results that include usage scores above a predetermined threshold, e.g., assets that have been used more than 100 times in the past week. In another example, the communication module 220 is programmed by the administrator to only send assets that include user quality ratings above a predetermined threshold, e.g., assets having a 2-star rating or higher. In yet another example, the communication module 220 only sends assets that include the user tags.

In at least one embodiment of the invention, the system further includes a repository of assets 230. More specifically, the system gathers and stores mobile assets in a repository that have been deemed popular by the processor 210. In at least one embodiment, the user and/or administrator of the system programs the processor 210 to identify mobile assets satisfying a predetermined level of popularity. For example, the user programs the processor 210 to identify mobile assets that have been downloaded more than 500 times in the past month. In another example, the administrator programs the processor 210 to gather all mobile assets having a “B-” user rating or above. In another embodiment, the processor 210 updates the repository of assets 230 in a dynamic or incremental basis (as defined by the user and/or administrator, e.g., update on a daily basis at 12:01 a.m.) by adding or removing mobile assets based on asset usage and/or user feedback.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute with the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

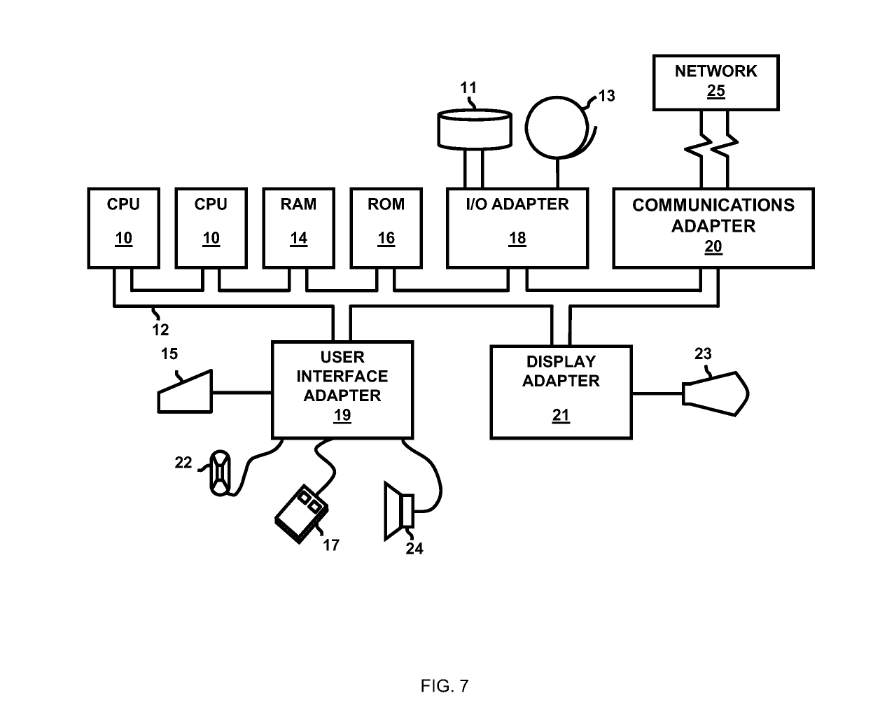

Referring now to FIG. 3, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 10. The CPUs 10 are interconnected with system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for searching for assets based on popularity, said method including:
determining popularities of assets in mobile devices with a processor, said determining including:
monitoring usage of the assets, and
gathering user feedback of the assets;
receiving a search query for a requested asset of the assets from a requesting mobile device;
weighing results of the search query with the popularities of the assets; and
sending the results of the search query to the requesting mobile device.

2. The method according to claim 1, wherein the usage of the assets includes at least one of downloading of the assets and launching of the assets.

3. The method according to claim 1, wherein the user feedback includes user tags.

4. The method according to claim 3, wherein said sending of the results of the search query includes only sending assets that include the user tags.

5. The method according to claim 1, wherein the user feedback includes user quality ratings.

6. The method according to claim 5, wherein said sending of the results of the search query includes only sending assets that include user quality ratings above a predetermined threshold.

7. The method according to claim 1, wherein said determining of the popularities of assets includes monitoring search queries for the assets.

8. The method according to claim 1, further including sending the results of the search query to an interface.

9. The method according to claim 1, further including creating a repository of assets based on the popularities of the assets.

10. A method for searching for assets based on popularity, said method including:
determining popularities of assets in mobile devices with a processor, said determining including:
monitoring usage of the assets, and
gathering user feedback of the assets, the user feedback including at least one of user tags and user quality ratings;
receiving a search query for a requested asset of the assets with a communication module, the search query being received from a requesting mobile device;
weighing results of the search query with a ranking module, the results of the search query being weighed with the popularities of the assets; and sending the results of the search query with the communication module, the results of the search query being sent to the requesting mobile device.

11. The method according to claim 10, wherein said sending of the results of the search query includes only sending assets that include at least one user tag.

12. The method according to claim 10, wherein said sending of the results of the search query includes only sending assets that include user quality ratings above a predetermined threshold.

13. The method according to claim 10, wherein said determining of the popularities of assets includes monitoring search queries for the assets.

14. The method according to claim 10, further including sending the results of the search query to an interface.

15. The method according to claim 10, further including creating a repository of assets based on the popularities of the assets.

16. A system for searching for assets based on popularity, said system including:
a processor for determining popularities of assets in mobile devices by monitoring usage of the assets and gathering user feedback of the assets;
a communication module for receiving a search query for a requested asset of the assets from a requesting mobile device; and
a ranking module for weighing results of the search query with the popularities of the assets,
said communication module sends the results of the search query to the requesting mobile device.

17. The system according to claim 16, wherein the usage of the assets includes at least one of downloading of the assets and launching of the assets.

18. The system according to claim 16, wherein the user feedback includes user tags.

19. The system according to claim 18, wherein said communication module only sends assets that include the user tags.

20. The system according to claim 16, wherein the user feedback includes user quality ratings.

21. The system according to claim 20, wherein said communication module only sends assets that include user quality ratings above a predetermined threshold.

22. The system according to claim 16, wherein said processor monitors search queries for the assets to further determine the popularities of assets.

23. The system according to claim 16, wherein said communication module further sends the results of the search query to an interface.

24. The system according to claim 16, further including a repository of assets based on the popularities of the assets.

25. A computer program product for searching for assets based on popularity, said computer program product including:
a computer readable storage medium;
first program instructions to determine popularities of assets in mobile devices with a processor, said determining including:
monitoring usage of the assets, and
gathering user feedback of the assets;
second program instructions to receive a search query for a requested asset of the assets from a requesting mobile device;
third program instructions to weigh results of the search query with the popularities of the assets; and
fourth program instructions to send the results of the search query to the requesting mobile device,
wherein the first program instructions, the second program instructions, the third program instructions, and the fourth program instructions are stored on the computer readable storage medium.
